(19) United States
(12) Patent Application Publication
(10) Pub. No.: US 2025/0025828 A1
(43) Pub. Date: Jan. 23, 2025

(54) Regeneration of Solvents Used in Carbon Dioxide Capture Process

(71) Applicant: TOTALENERGIES ONETECH, Courbevoie (FR)

(72) Inventors: Parveen KUMAR, Seneffe (BE); Walter VERMEIREN, Seneffe (BE)

(21) Appl. No.: 18/714,213

(22) PCT Filed: Nov. 28, 2022
(86) PCT No.: PCT/EP2022/083535

§ 371 Date: May 29, 2024

(30) Foreign Application Priority Data
Nov. 29, 2021 (EP) 21315250.7

(51) Int. Cl. B01D 53/14; B01D 53/18; B01D 53/62; B01D 53/78; B01D 53/96

(52) U.S. Cl. CPC B01D 53/1425; B01D 53/1475; B01D 53/18; B01D 53/62; B01D 53/78; B01D 53/96; B01D 2257/504

(57) ABSTRACT

Method to desorb CO₂ in a CO₂-rich solvent in a stripper column comprising the steps of providing a first stream comprising a CO₂-rich solvent; providing a stripper column; passing the first stream through the stripper column; recovering a CO₂-rich effluent and a re-boiler stream from the stripper column and passing the reboiler stream through the reboiler and recovering a second stream comprising a CO₂-lean solvent from the reboiler. The method further comprises one or more steps of hydrodynamic cavitation which are performed on the first stream and/or on the reboiler stream, each stream presenting an initial flow velocity and an initial static pressure, wherein hydrodynamic cavitation is performed by increasing the initial flow velocity of the stream and subsequently decreasing the initial static pressure of the stream, and wherein hydrodynamic cavitation is performed within the stripper column and/or on a stream directly entering or directly exiting the stripper column.

### TECHNICAL FIELD

The disclosure relates to a method to desorb carbon dioxide from a CO₂-rich solvent in a stripper system and to a stripper system configurated for performing such a method. The disclosure also relates to an anthropogenic carbon dioxide capture process using the said method to desorb carbon dioxide from a CO₂-rich solvent and to an installation to carry out such a process.

### TECHNICAL BACKGROUND

Global warming and climate change caused by human emissions of greenhouse gases have become a major concern to the public. Major policy initiatives such as the Paris Climate Agreement of 2017 and the European Green deal of 2019 are demanding actions to reduce those emissions from all sectors in society, including the chemical industry.

Power plants, for example, produce flue gas as combustion exhaust gas. The composition of the flue gas depends on what is being burned but comprises mainly nitrogen (50 wt. % to 70 wt. % based on the total weight of the flue gas) and carbon dioxide (4 wt. % to 20 wt. % based on the total weight of the flue gas). Other components are present, such as water vapour, oxygen, and pollutants like particulate matter (i.e., soot), carbon monoxide, nitrogen oxides and sulfur oxides. To reduce the impact of the chemical industry, efforts have already been considered to control the release of carbon dioxide into the atmosphere.

Indeed, cleaning processes exist to decrease the number of greenhouse gases or pollutants present in the flue gas. For example, the carbon dioxide capture process, such as the post-combustion capture process wherein carbon dioxide is separated from the flue gas before it enters the atmosphere can be implemented. The removal of the carbon dioxide from the flue gas is performed in an absorber-stripper system, in which the carbon dioxide is absorbed in a solvent in the absorption zone of such a system. The stripper zone is there for recovering the CO₂ from the solvent and regenerating the solvent.

Those regeneration processes in the stripper zone are energy-intensive due to the high temperatures that are required. Indeed, the regeneration process is usually done at a temperature above the boiling temperature, as the chemical kinetics of regeneration increases with temperature. As noted in the study entitled “Structure and activity relationships for CO₂ regeneration from aqueous amine-based solvents” by Singh P. et al. (Process safety and environment protection, 2008, 86, 347-359), the energy consumption in the regeneration process is estimated to constitute about 15% to 30% of the net power production of a coal-fired power plant for about 90% CO₂ removed. In the study entitled “A review: Desorption of CO₂ from rich solutions in chemical absorption processes” by Li T., et al., (International Journal of Greenhouse Gas Control, 2016, 51, 290-304), it is mentioned that more than 90% of the total process energy requirement can stem from the regeneration of the rich solutions in the stripper system and is supplied generally as a reboiler steam, referred to as reboiler heat duty. This reboiler heat duty is mainly used for three purposes: raising the temperature of the CO₂-rich solvent to the reboiler temperature, providing heat to reverse the chemical reaction (i.e., to the desorption reaction) and generating heat of water vaporization. It was believed that solvents with higher heat of absorption require more heat to be regenerated but the study entitled “Minimising the regeneration heat duty of post-combustion CO₂ capture by wet chemical absorption: the misguided focus on low heat of absorption solvents” by Oexmann J. et al. (International Journal of Greenhouse Gas Control, 2010, 4, 36-43) pointed out that the focus on the development of low heat of absorption solvents might be misguiding.

It is also pointed that improving the kinetics of the desorption reaction by increasing the desorption temperature is not always the best solution since upon repetition of the regeneration cycles, degradation of the solvents might occur, which is detrimental to the environment and affects the performance of the process over a given period. Also, corrosion problems of the equipment might occur, which is not ideal for the long-term implementation of the CO₂ capture process.

CA 3 061 855 relates to a method to desorb CO₂ from a CO₂-rich solvent using hydrodynamic cavitation units. There is a degasser unit between the cavitation unit and the stripper column in order to release the CO₂ bubbles created within the cavitation unit.

Another approach to reducing the cost of solvent regeneration has been envisioned, notably by implementing new process configurations to take advantage of better energy integration and to reduce its energy consumption. For instance, the studies entitled “Ultrasound intensified CO₂ desorption from pressurized loaded monoethanolamine solution.” of Ying J., et al. (Energy, 2018, 163, 168-179, and Energy, 2019, 173, 218-228) have proposed the use of cavitation induced by ultrasound to reduce the energy requirement associated with the regeneration of the solvent in the stripper system. Cavitation is associated with the formation, growth and collapse of microbubbles leading to the generation of very high temperatures locally. This enhances the chemical reactions and the associated mass transfer related to the stripping of carbon dioxide from an absorbent in the stripper. They reported that at low temperatures ultrasound energy was used for heating which is already a step forward into the optimization of the energy savings. However, to enhance the CO₂ stripping itself, the ultrasound frequencies (about 20 kHz to 28 kHz) must be implemented at reboiler temperature, namely at an elevated temperature of 130° C.

WO2009/127440 (or EP 2 276 551) describes a method and a device for separating carbon dioxide from stacks, sludges and/or exhaust gases in which the absorption agent enriched with CO₂ is subjected to an ultrasonic treatment at a temperature comprised between 40° C. and below 80° C. following the absorption of CO₂. However, one of the major drawbacks of cavitation by use of ultrasound is the ability to scale up the cavitation to that required in an industrial stripper since the description of the patent relate to a volume of 3.15 litres.

JP H07 100333 relates to a method for regenerating a CO₂ absorbent for absorbing CO₂ contained in flue gas and to a method for removing CO₂ contained in the flue gas. The removal of the CO₂ is performed in an ultrasonic wave generator which is installed in a reboiler.

WO 2017/039131 relates to an acid gas collection system and an acid gas collection method, wherein an ultrasonic device is placed between a reboiler and a stripping tower or between an absorption tower and a heat changer upstream to a reboiler.

CN 103 638 780 relates to a system and method for enhanced regeneration of CO₂ capture solution. The system comprises a regeneration tower, with an ultrasonic generator panel that is located below the liquid level to achieve an ultrasonic cavitation that facilitates the escape of CO₂ from the liquid phase that is within the regeneration tower, possibly heated via a reboiler.

The present disclosure aims to intensify the desorption of CO₂ from the absorbent to enhance the solvent regeneration in a CO₂ capture process by allowing a long-term industrial implementation of such a process (in other words, by preventing the potential degradation of the solvent).

### SUMMARY

In a first aspect, the disclosure relates to a method to desorb carbon dioxide from a CO₂-rich solvent in a stripper column, the method comprising the steps of
i. providing a first stream comprising a CO₂-rich solvent;
ii. providing a stripper column and a reboiler;
iii. passing the first stream through the stripper column under stripping conditions;
iv. recovering a CO₂-rich effluent from the stripper column,
v. recovering a reboiler stream from the stripper column and passing the reboiler stream through the reboiler, and
vi. recovering a second stream comprising a CO₂-lean solvent from the reboiler;
the method is remarkable in that it comprises one or more steps of hydrodynamic cavitation which are performed on the first stream and/or on the reboiler stream, each stream presenting an initial flow velocity and an initial static pressure, in that the one or more steps of hydrodynamic cavitation are performed by increasing the initial flow velocity of the stream and subsequently decreasing the initial static pressure of the stream; and in that at least one step of hydrodynamic cavitation is performed within the stripper column and/or at least one step of hydrodynamic cavitation is performed on a stream directly entering or directly exiting the stripper column.

Surprisingly, it was found that the intensification of the CO₂ desorption from an absorbent rich in CO₂ can be implemented at a large scale by providing one or more hydrodynamic cavitation steps during the stripping of the solvent. Hydrodynamic cavitation, which is an implementation of Bernoulli's principle which states that an increase of the speed of a fluid occurs simultaneously with a decrease of its static pressure, allows the formation of numerous cavities within the liquid stream. Cavitation is a physical phenomenon associated with three aspects: formation (vaporization), growth and collapse (implosion) of vapor/gas bubbles within a liquid due to variations of local static pressure. Cavitation bubbles are indeed formed in the low-pressure region where pressure becomes lower than the vapor pressure of some components of the liquid and be carried into the higher-pressure region where they collapse. Decreasing the pressure over a liquid and bringing it to its vapor pressure at the operating temperature generates vapor bubbles in the liquid. Bubbles generated will collapse with a subsequent recovery above the vapor pressure. Such intense conditions (500 MPa and 12,000 K, intense turbulence) and resulting shock waves can bring about several physical, chemical & biological transformations, even when the bulk conditions are ambient. However, the overall environment remains at the operating conditions, which can be kept within a reasonable threshold, namely under ambient or slightly higher than ambient conditions. Therefore, the method to capture carbon dioxide in CO₂-rich solvent in a stripper column according to the present disclosure allows efficiently desorbing the carbon dioxide, without providing an excess of heat, which allows in fine to preserve the solvent used for absorbing the carbon dioxide since the risks of degradation of solvent are minimized. Also, without an excess of heat, corrosion problems can be avoided and/or the energy consumption is optimized. Overall, the method according to the present disclosure can be implemented industrially, because it does not require sophisticated maintenance to be worked.

The one or more hydrodynamic cavitation steps are performed in absence of ultrasonic waves; preferably all the hydrodynamic cavitation steps are performed in absence of ultrasonic waves. This allows the method to be implemented at a large scale.

For example, the one or more steps of hydrodynamic cavitation are selected from a first type of hydrodynamic cavitation performed on the first stream before step (iii), a second type of hydrodynamic cavitation performed on the first stream within the stripper column, a third type of hydrodynamic cavitation performed on the reboiler stream; a fourth type of hydrodynamic cavitation performed on at least one part of a liquid portion withdrew from the stripper column followed by reinjecting said part of the liquid portion that has been subjected to hydrodynamic cavitation into the stripper column; and any combination thereof.

For example, at least one step of hydrodynamic cavitation is selected from a first type of hydrodynamic cavitation performed on the first stream before step (iii), a second type of hydrodynamic cavitation performed on the first stream within the stripper column, a third type of hydrodynamic cavitation performed on the reboiler stream; a fourth type of hydrodynamic cavitation performed on at least one part of a liquid portion withdrew from the stripper column followed by reinjecting said part of the liquid portion that has been subjected to hydrodynamic cavitation into the stripper column; and any combination thereof.

Advantageously, the initial static pressure of each stream corresponds to the vapor pressure of the stream under the stripping conditions of step (iii).

For example, the first stream provided at step (i) shows a temperature ranging from 50° C. to less than 130° C.; preferably, from 55° C. to 105° C., more preferably, from 60° C. to 100° C.; even more preferably, from 65° C. to 95° C., or from 70° C. to 90° C.

For example, the initial static pressure of the first stream is ranging between 0.10 MPa and 0.30 MPa; preferably from 0.15 MPa to 0.25 MPa.

For example, the stripper column is in a fluidic connection with a reboiler, and the stripping conditions of step (iii) comprise providing heat to the reboiler. This can be done by electric heating and/or steam and/or any hot fluids. For example, the stripping conditions of step (iii) comprise temperature conditions ranging from 85° C. to 140° C.; preferably from 90° C. to 135° C., more preferably from 95° C. to 130° C., even more preferably from 100° C. to 125° C., most preferably, from 105° C. to 120° C.

Advantageously, the method is remarkable in that the reboiler stream is heated to a temperature ranging from 85° C. to 140° C., preferably from 90° C. to 135° C., more preferably from 95° C. to 130° C., even more preferably from 100° C. to 125° C., most preferably, from 105° C. to 120° C., so as to produce a second stream. With preference, the first stream provided at step (i) shows a temperature ranging from 50° C. to less than 130° C. and at least a part of the heat required for heating the first stream to the said temperature is provided by heat transfer from the second stream; with preference, the first stream provided at step (i) shows a temperature ranging from 55° C. to 105° C., more preferably, from 60° C. to 100° C.; even more preferably, from 65° C. to 95° C., or from 70° C. to 90° C.

In an embodiment, at least one step of hydrodynamic cavitation is performed on a stream directly entering the stripper column, wherein the stream is the first stream and wherein no other step is performed between the step of hydrodynamic cavitation and the step of passing the first stream through the stripper column.

In an embodiment, at least one step of hydrodynamic cavitation is performed on a stream directly exiting the stripper column wherein the stream is the reboiler stream and wherein no other step is performed between exiting of reboiler stream from the stripper column and the step of hydrodynamic cavitation.

In an embodiment, at least one step of hydrodynamic cavitation is performed within the stripper column by means of one or more hydrodynamic cavitation devices being arranged within the stripper column.

In an embodiment, at least one step of hydrodynamic cavitation is performed on a stream directly exiting the stripper column wherein the stream is a liquid portion withdrew from the stripper column and reinjected into the stripper column and wherein no other step than step of hydrodynamic cavitation is performed between the withdrawal of the liquid portion and its reinjection into the stripper column.

In an embodiment, one or more steps of hydrodynamic cavitation are performed on the first stream and at least one additional hydrodynamic cavitation step is performed on the reboiler stream.

In an embodiment, one or more steps of hydrodynamic cavitation are performed on the first stream and at least one additional hydrodynamic cavitation step is performed within the reboiler.

Advantageously, the method is remarkable in that at least one step of hydrodynamic cavitation is carried out on the reboiler stream, the step of hydrodynamic cavitation being carried out before and/or during a step of heating the reboiler stream.

CO₂ emissions originate from three main areas: fuel combustion activities, industrial processes, and natural-gas processing. These CO₂ emissions due to human activities are called anthropogenic carbon dioxide emissions.

The largest CO₂ emissions result from the oxidation of carbon when fossil fuels or biogenic fuels are burned in power plants, oil refineries and large industrial facilities. Post-combustion CO₂ capture refers to the removal of CO₂ from combustion flue gas before discharge to the atmosphere. It is referred to as “post-combustion capture” because the CO₂ is the product of the combustion of the primary fuel and the capture takes place after the combustion of that fuel.

Carbon dioxide not related to combustion is emitted from a variety of industrial production processes which transform materials chemically, physically, or biologically. Such processes include:
the use of fossil carbon-containing streams as feedstocks in petrochemical processes;
the use of carbon-containing streams as a reducing agent in the commercial production of metals from ores;
the thermal decomposition (calcination) of limestone and dolomite in cement or lime production;
the fermentation of biomass (e.g., to convert sugar to alcohol);
Another source occurs in natural-gas processing installations. CO₂ is a common impurity in natural gas, and it must be removed to improve the heating value of the gas or to meet pipeline specifications

In a second aspect, the disclosure relates to an anthropogenic carbon dioxide capture process, the process comprising the following steps:
a) providing a stream of CO₂-containing gas;
b) providing a solvent being or comprising an absorbent of carbon dioxide;
c) contacting the stream of CO₂-containing gas with the solvent being or comprising an absorbent, so as to recover a CO₂-rich solvent;
d) directing the CO₂-rich solvent in a stripper column;
e) desorbing the carbon dioxide from the CO₂-rich solvent;
   the process is remarkable in that step (e) is performed according to the method to desorb the carbon dioxide from a CO₂-rich solvent in a stripper column as defined in the first aspect.

With preference, the absorbent is or comprises one or more selected from amines, amino-alcohols, amino-sulphides, amino acids, ammonia, carbonate salts, bicarbonate salts, hydroxide salts, ionic liquids and any combination thereof.

Amines are commonly classified by the degree of substitution on the central nitrogen; a single substitution denoting a primary amine; a double substitution, a secondary amine; and a triple substitution, a tertiary amine.

In an embodiment, the absorbent is or comprises amino-alcohols. For example, when the absorbent is or comprises amino-alcohols, the amino-alcohols are one or more alkanolamines are selected from one or more of monoethanolamine (MEA), diethanolamine (DEA), triethanolamine (TEA), methyldiethanolamine (MDEA), di-glycol-amine, di-isopropanol amine (DIPA), 2-amino-2-methyl-1-propanol (AMP). With preference, when the absorbent comprises amino-alcohols, the absorbent further comprises benzylamine (BZA) and/or piperazine (PZ).

Ionic liquids are organic salts with elevated boiling points and thus low vapor pressure, which can selectively absorb acid gases such as CO₂. Ionic liquids are typically formed with the combination of a large organic cation, that is, imidazolium, pyridinium or phosphonium cation with either an inorganic anion such as Cl⁻, BF₄⁻ and PF₆⁻, or an organic anion, that is, RCOO⁻ and CF₃SO₃⁻.

For example, the CO₂-containing gas provided as a stream in step (a) comprises between 1 vol. % and 65 vol. % of CO₂ based on the total volume of said CO₂-containing gas, preferably between 5 vol. % and 50 vol. %.

For example, the CO₂-containing gas provided as a stream in step (a) is flue gas.

For example, the anthropogenic carbon dioxide capture process of the second aspect is a post-combustion carbon dioxide capture process and the CO₂-containing gas provided as a stream in step (a) is a stream of flue gas. With preference, the flue gas provided as a stream in step (a) comprises carbon dioxide, nitrogen and one or more of water, carbon monoxide, oxygen, nitrogen oxides and sulphur oxides. For example, the flue gas provided as a stream in step (a) further comprises particulate matters, such as soot. For example, the flue gas provided as a stream in step (a) comprises carbon dioxide in an amount ranging from 4 wt. % to 20 wt. % of the total weight of flue gas. For example, the flue gas provided as a stream in step (a) comprises nitrogen in an amount ranging from 50 wt. % to 70 wt. % of the total weight of flue gas.

In a third aspect, the disclosure relates to a stripper system for desorbing carbon dioxide from a CO₂-rich solvent as defined in the method according to the first aspect, the stripper system comprising
a stripper column, the stripper column having a top zone and a bottom zone,
a reboiler, wherein the reboiler is arranged downstream of the stripper column and the bottom zone of the stripper column is in fluidic connection with the reboiler,
an input line in fluidic connection with the top zone of the stripper column, and
a reboiler line between the bottom zone of said stripper column and the reboiler,
   the stripper system is remarkable in that it comprises one or more hydrodynamic cavitation devices, the one or more hydrodynamic cavitation devices presenting a constricting section and/or a vortex diode showing a tangential inlet port and an axial outlet port;
   and wherein at least one hydrodynamic cavitation device is placed
within the stripper column; and/or
on a line directly entering or directly exiting the stripper column; and/or
at an inlet or at an outlet of the stripper column.

In an embodiment, the line directly entering the stripper column is selected from the input line and a line in parallel of the stripper column.

In an embodiment, the line directly exiting the stripper column is selected from the reboiler line and a line in parallel of the stripper column.

For example, the constriction section is formed by one or more selected from an orifice plate with at least one hole, a venturi tube, a rotor-stator system and a liquid whistle.

For example, one or more hydrodynamic cavitation devices are placed on one or more selected from on the input line, within the stripper column, in parallel to the stripper column, on the reboiler line and within the reboiler.

For example, one or more hydrodynamic cavitation devices are installed on the input line.

For example, one or more hydrodynamic cavitation devices are installed within the stripper column.

For example, one or more hydrodynamic cavitation devices are installed in parallel to the stripper column.

For example, one or more hydrodynamic cavitation devices are installed on the reboiler line.

Advantageously, the stripping column contains internals in order to maximise the liquid-vapor interface area. The internals can be trays, packing or combinations of both. For example, the packing is random or structured. With preference, the random packings (Pall rings, Raschig rings, saddle rings, etc.) are made of metal, plastic, ceramic. They are in general relatively inexpensive. The advantages of random packings are high strength, low weight, fouling resistance, easily interchangeable and cleanable. With preference, structured packings are honeycomb (waffle, herringbone) block structures made of plastic or metal. The advantages of structured packings are the higher efficiency, the efficient use made of the available surface and lower pressure-drop they provide, compared to either random packings or trays.

Concerning trays, the trays can be valve trays, sieve trays, bubble cap trays or a combination thereof. Valve trays are perforated metal sheets on which round, liftable valves are mounted. The vapors flow through valves that are installed parallel to the outlet weir. Valve trays combine high capacity and excellent efficiency with a wide operating range. Sieve trays are flat perforated plates in which vapor rises through small holes in the tray floor and bubbles through the liquid in a fairly uniform manner. Bubble cap trays allow vapor to rise through holes in the tray and is collected underneath bubble caps. Each cap has slots in it through which the vapor from the tray below bubbles into the liquid on the tray.

Advantageously, the stripper system further comprises a gas/liquid separator, the gas/liquid separator being downstream and fluidly connected to the top zone of the stripper column. With preference, the stripper system further comprises a gas compressor downstream of the gas/liquid separator and/or a line to recycle liquid (for example by reflux) into the top zone of the stripper column.

Advantageously, at least one hydrodynamic cavitation device is installed before or within the reboiler and/or the reboiler comprises at least one line to convey vapours into the stripper column through the steam input line.

In a fourth aspect, the disclosure relates to an installation to perform an anthropogenic carbon dioxide capture process according to the second aspect, the installation comprising
an absorber column, the absorber column showing a top zone and a bottom zone, the top zone of the absorber column presenting an output exhaust;
a feed line being a first line in fluidic connection with the bottom zone of the absorber column;
a stripper system;
a second line fluidly connecting the bottom zone of the absorber column with an input line of said stripper system;
   the installation is remarkable in that the stripper system is the stripper system for desorbing carbon dioxide from a CO₂-rich solvent as defined in the third aspect.

With preference, the installation comprises a cooler system upstream to the absorber column and into which the first line passes through.

For example, the installation further comprises a heat exchanger through which the second line passes, and a third line fluidly connecting the reboiler and the top zone of the absorber column, the third line also passing through the heat exchanger.

### DESCRIPTION OF THE FIGURES

FIG. 1 describes a stripper system of an installation to perform an anthropogenic carbon dioxide capture process in which one hydrodynamic cavitation device 9 is installed on the input line 5, namely upstream of the stripper column 1.

FIG. 2 describes a stripper system of an installation to perform an anthropogenic carbon dioxide capture process in which one hydrodynamic cavitation device 9 is installed within the stripper column 1 itself.

FIG. 3 describes a stripper system of an installation to perform an anthropogenic carbon dioxide capture process in which one hydrodynamic cavitation device 9 is installed on the reboiler line 7, namely downstream of the stripper column 1 and upstream of the reboiler 3.

FIG. 4 describes a stripper system of an installation to perform an anthropogenic carbon dioxide capture process in which one hydrodynamic cavitation device 9 is installed in parallel to the stripper column 1.

### DETAILED DESCRIPTION

During an anthropogenic capture process, such as a post-combustion carbon dioxide capture process, the carbon dioxide is firstly absorbed from a CO₂-containing gas, or a flue gas by a CO₂-lean solvent present in an absorber, operating at nearly atmospheric pressure.

For example, the CO₂-containing gas provided as a stream in step (a) comprises between 1 vol. % and 65 vol. % of CO₂ based on the total volume of said CO₂-containing gas, preferably between 5 vol. % and 50 vol. %. For example, the CO₂-containing gas provided as a stream in step (a) is flue gas. For example, the anthropogenic carbon dioxide capture process of the second aspect is a post-combustion carbon dioxide capture process and the CO₂-containing gas provided as a stream in step (a) is a stream of flue gas.

The absorber is usually a solvent capable of forming a weak bond with carbon dioxide. Different families of chemical solvents that are used for carbon dioxide capture include amine or salt solutions-based solvents. Secondly, after CO₂ absorption, the gas leaving the absorber column may be washed with water in a washing section to reduce solvent loss. Cleaned gas at least devoid of most carbon dioxide, can then be released into the atmosphere. The cold solvent rich in carbon dioxide leaves the bottom of the absorber and after being preferably preheated by the hot CO₂-lean solvent in a heat exchanger 19, enters a stripper system comprising a stripper column 1, at a temperature ranging from 50° C. to less than 130° C., for example from 60° C. to 120° C., and/or under a pressure ranging from 0.10 MPa to 0.30 MPa. Thanks to a reboiler 3 which generates heat via electric heating and/or steam and/or any hot fluids, the vapor is transferred to the stripper column 1 through a heating line 29 and strips the carbon dioxide out of the CO₂-rich solvent. The warm CO₂-lean solvent then leaves the bottom of the stripper column 1 and is preferably cooled down by the cold solvent rich in carbon dioxide to be then recycled to the absorber after being passed into an aftercooler (not shown). The stripped gas (i.e., CO₂) that is recovered from the stripper column 1 can be also washed in a washing section downstream of the stripper column 1, after which its water content is condensed in a partial condenser, i.e., in a gas/liquid separator 13. The stripped gas is thus recovered and can be, after compression, conveyed into storage or be used for chemical or biochemical conversion into useful products.

The disclosure relates therefore to a method to desorb carbon dioxide from a CO₂-rich solvent in a stripper column 1, the method comprising the steps of
i. providing a first stream comprising a CO₂-rich solvent;
ii. providing a stripper column 1 and a reboiler 3;
iii. passing the first stream through the stripper column 1 under stripping conditions;
iv. recovering a CO₂-rich effluent from the stripper column 1,
v. recovering a reboiler stream from the stripper column 1 and passing the reboiler stream through the reboiler 3, and
vi. recovering a second stream comprising a CO₂-lean solvent from the reboiler 3.

The method of the present disclosure is remarkable in that it comprises one or more steps of hydrodynamic cavitation which are performed on the first stream and/or on the reboiler stream, each stream presenting an initial flow velocity and an initial static pressure, in that the one or more steps of hydrodynamic cavitation are performed by increasing the initial flow velocity of the stream and subsequently decreasing the initial static pressure of the stream, and in that at least one step of hydrodynamic cavitation is performed within the stripper column 1 and/or at least one step of hydrodynamic cavitation is performed on a stream directly entering or directly exiting the stripper column.

According to the disclosure, one or more hydrodynamic cavitation steps are performed in absence of ultrasonic waves; preferably all the hydrodynamic cavitation steps are performed in absence of ultrasonic waves.

In an embodiment, the method according to any at least one step of hydrodynamic cavitation is performed on a stream directly entering the stripper column 1, wherein the stream is the first stream and wherein no other step is performed between the step of hydrodynamic cavitation and the step of passing the first stream through the stripper column 1.

For example, at least one step of hydrodynamic cavitation is performed on a stream directly exiting the stripper column 1 wherein the stream is the reboiler stream and wherein no other step is performed between exiting of reboiler stream from the stripper column 1 and the step of hydrodynamic cavitation.

For example, at least one step of hydrodynamic cavitation is performed within the stripper column 1 by means of one or more hydrodynamic cavitation devices being arranged within the stripper column 1.

For example, at least one step of hydrodynamic cavitation is performed on a stream directly exiting the stripper column 1 wherein the stream is a liquid portion withdrew from the stripper column 1 and reinjected into the stripper column 1 and wherein no other step than step of hydrodynamic cavitation is performed between the withdrawal of the liquid portion and its reinjection into the stripper column 1.

For example, one or more steps of hydrodynamic cavitation are performed on the first stream and at least one additional hydrodynamic cavitation step is performed on the reboiler stream.

For example, one or more steps of hydrodynamic cavitation are performed on the first stream and at least one additional hydrodynamic cavitation step is performed within the reboiler 3.

The stripper column 1 is part of a stripper system having an input line 5 in fluidic connection with a top zone of the stripper column 1 and a reboiler line 7 fluidly connecting a reboiler 3 which is arranged downstream of the stripper column 1. For the method of the present disclosure to be worked, the stripper system 1 is remarkable in that it comprises one or more hydrodynamic cavitation devices 9 which present a constricting section and/or a vortex diode showing a tangential inlet port and an axial outlet port. When the stream goes through the constricting section or through a vortex diode, its flow velocity increases leading to a subsequent decrease of its static pressure which allows the formations of cavities.

For example, the initial static pressure of each stream corresponds to the vapor pressure of the stream under the stripping conditions of step (iii). Therefore, microbubbles are created when the pressure of the most volatile components of the fluid drops below the vapor pressure.

For example, the initial static pressure of the first stream is ranging between 0.10 MPa and 0.30 MPa, preferably, from 0.15 MPa to 0.25 MPa.

The stripping conditions of step (iii), when the first stream is passed through the stripper column 1, advantageously comprises passing steam through the stripper column 1. Steam allows for the removal of carbon dioxide from the solvent in which the carbon dioxide is absorbed. For example, the stripping conditions of step (iii) can also comprise temperature conditions ranging from 85° C. to 140° C.; preferably from 90° C. to 135° C., more preferably from 95° C. to 130° C., even more preferably from 100° C. to 125° C., most preferably, from 105° C. to 120° C. The stripping conditions of step (iii) can also comprise an overall pressure corresponding to the atmospheric pressure, namely about 0.1 MPa or under a pressure ranging from 0.10 MPa to 0.30 MPa; preferably, from 0.15 MPa to 0.25 MPa.

A pre-heater 23 can be advantageously installed on the input line 5 of the stripper system. This can result in the fact that the first stream provided at step (i) is heated to a temperature ranging from 50° C. to less than 130° C., preferably, from 55° C. to 105° C., more preferably, from 60° C. to 100° C.; even more preferably, from 65° C. to 95° C., or from 70° C. to 90° C., before entering the stripper column 1. However, the energy required for providing the first stream at a temperature that is appropriate for the desorption reaction to being worked is preferably furnished not only by the pre-heater 23 but also by a reboiler 3, or by a reboiler 3 only. The pre-heater 23 is the one that is usually implemented to maintain the steam that is directed to the stripper column 1 at an appropriate temperature.

Advantageously, the stripper system of the present disclosure is part of an installation to perform an anthropogenic carbon dioxide capture process to remove carbon dioxide from a stream of CO₂-containing gas, for example from a stream of flue gas. Such installation comprises an absorber column showing a top zone and a bottom zone. The top zone of the absorber column comprises an output exhaust, to reject the CO₂-containing gas, or the flue gas, that has been treated, namely a gas presenting a content of CO₂ that is at most 5 wt. % of the total weight of the gas, preferably at most 1 wt. % or that is more preferably devoid of CO₂.

A feed line, through which the CO₂-containing gas, or the flue gas, is conveyed into the absorber column, is a first line that is in fluidic connection with the bottom zone of the absorber column. The bottom zone of the absorber column is fluidly connected to a second line 17 which connects the bottom zone of the absorber column with a top zone of a stripper column 1. An optional cooler system can be placed on the first line to cool the CO₂-containing gas or the flue gas before it enters the absorber column.

To maximize the efficiency of such an installation, the reboiler stream comprising a solvent substantially devoid of carbon dioxide, or presenting a content of CO₂ that is at most 5 wt. % of the total weight of the CO₂-lean solvent, preferably at most 1 wt. %, more preferably at most 0.1 wt. %, can be recovered from the stripper column 1 and can be thus directed to an absorber column. The reboiler stream is then passed through a reboiler 3 to be heated at a temperature ranging from 85° C. to 140° C., preferably from 90° C. to 135° C., more preferably from 95° C. to 130° C., even more preferably from 100° C. to 125° C., most preferably, from 105° C. to 120° C. The reboiler 3 is installed downstream of the stripper column 1, with a line directing the second stream (i.e. the hot stream) exiting the reboiler 3 to a heat exchanger 19 where its heat is exchanged with the first stream of CO₂-rich solvent while the second stream of CO₂-lean solvent cools down. Thus, the CO₂-lean solvent is passed through the absorber column and capture the carbon dioxide.

As the installation can also comprise a heat exchanger 19 through which the second line 17 passes, the line, being a third line 21, directing the second stream exiting the reboiler 3 to the top zone of the absorber column also passed through the heat exchanger 19. Thus, with preference, the first stream provided at step (i) shows a temperature ranging from 50° C. to less than 130° C., and at least a part of the heat required for allowing the first stream to reach the temperature is provided by heat transfer from the second stream; more preferably, the first stream provided at step (i) shows a temperature ranging from 55° C. to 105° C., even more preferably, from 60° C. to 100° C.; most preferably, from 65° C. to 95° C., or from 70° C. to 90° C.

The presence of the pre-heater 23 is therefore not compulsory but can also help for providing sufficient heat to the first stream provided at step (i). This configuration is thus interesting in that the first stream comprising a CO₂-rich solvent is heated by use of the reboiler that is usually installed to maintain either steam or any hot solvents at an appropriate temperature for performing the desorption of carbon dioxide. There is no need to provide other equipment for heating the first stream, rendering, therefore, the installation more energy efficient.

At least a part of this second stream, or preferably all this second stream, is then directed to the top zone of the absorber column so that a part or all of the CO₂-lean solvent is regenerated for absorbing carbon dioxide from the CO₂-containing gas or the flue gas. Thus, this configuration allows for recycling the CO₂-lean solvent and thus avoiding its waste.

Advantageously, the stripper column 1 comprises a packed bed 11. With preference, the packed bed 11 comprises one or more selected from Pall rings, Raschig rings, or saddle rings.

More preferably, the packed bed 11 comprises a Raschig ring.

In connection with the top zone of the stripper column 1, the stripper system can comprise a gas/liquid separator 13 that is used to separate the carbon dioxide from the water coming from the stripping. The gas/liquid separator 13 is fluidly connected to the top zone of the stripper column through a separation line 25, which can optionally comprise a cooler 27 to enhance the efficiency of the gas/liquid separator 13. The water, after having been condensed into the gas/liquid separator 13, can then be reinjected into the stripper column 1 through a recycling line 15. The gas (i.e., the carbon dioxide) that has been separated can further be conveyed into a gas compressor (not shown) that is disposed downstream of the gas/liquid separator 13 before being conveyed into storage.

To intensify the desorption process into the stripper system, one or more hydrodynamic cavitation steps can be performed. During the one or more hydrodynamic cavitation steps, cavitation bubbles are formed within the stream subjected to the one or more hydrodynamic cavitation steps. The cavitation bubbles then expand until they collapse. While collapsing, they release a certain amount of energy that is enhancing the desorption process, at least by weakening the bonding between the carbon dioxide and the absorbent and/or by breaking a certain amount of bonding, leaving a remaining quantity to be desorbed that is less important by comparison to whether such one or more hydrodynamic cavitation steps were not carried out. Those one or more hydrodynamic cavitation steps, therefore, facilitate the desorption of carbon dioxide and subsequently the regeneration of the CO₂-lean solvent.

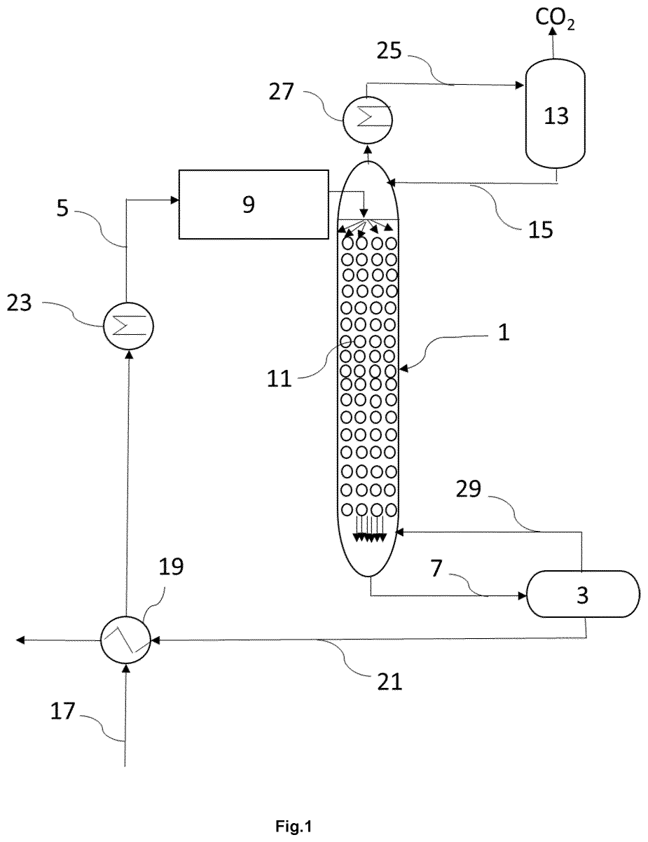

Thus, the hydrodynamic cavitation step can be of a first type, namely a first type of hydrodynamic cavitation step performed on the first stream before step (iii) and involves a stripper system having a hydrodynamic cavitation device 9 installed on the input line 5, for example on a line directly entering the stripper column 1. FIG. 1 illustrates this configuration.

In another example, the stripper system can have a hydrodynamic cavitation device 9 installed at an inlet of the stripper column 1.

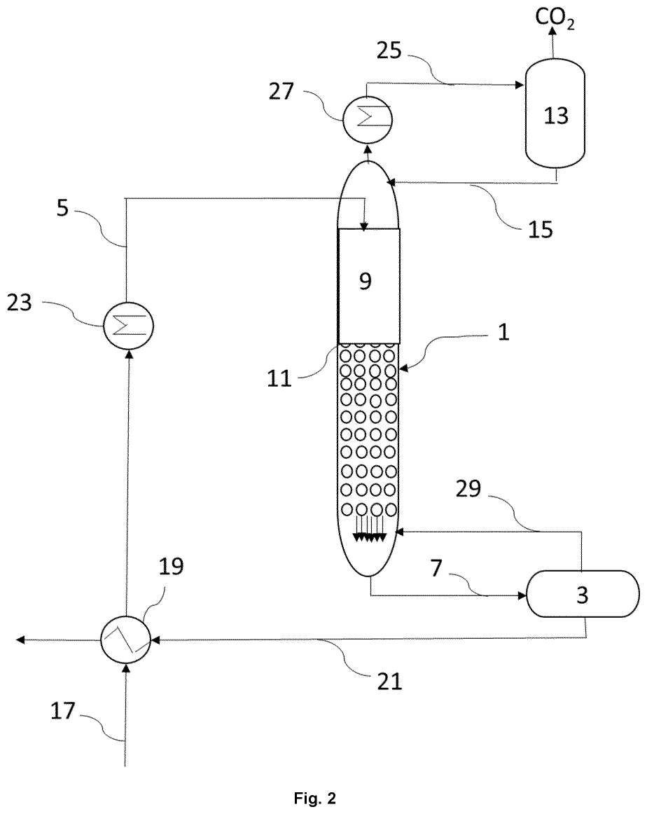

The hydrodynamic cavitation step can also be of a second type, namely a second type of hydrodynamic cavitation step performed on the first stream within the stripper column 1 and involves a stripper system having a hydrodynamic cavitation device 9 installed within the stripper column 1. FIG. 2 illustrates this configuration.

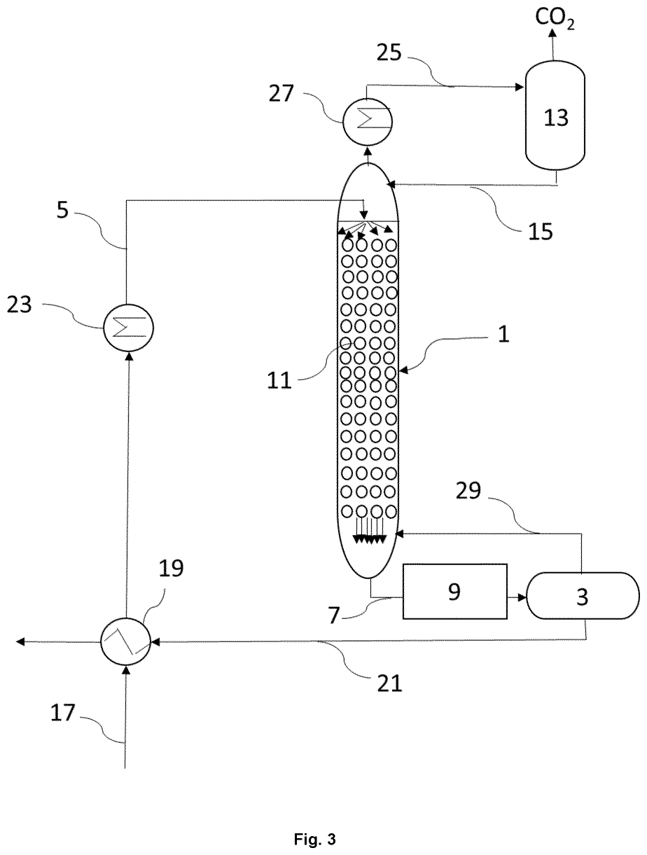

The hydrodynamic cavitation step can also be of a third type, namely a third type of hydrodynamic cavitation step performed on the reboiler stream. The solvent in the reboiler stream exiting the stripper column 1 is a solvent substantially devoid of carbon dioxide but may still present a content of CO₂ that is at most 5 wt. % of the total weight of the solvent, preferably at most 1 wt. %, more preferably at most 0.1 wt. %. This third type of hydrodynamic cavitation involves a stripper system having a hydrodynamic cavitation device 9 installed on a reboiler line 7 which is connecting the bottom zone of the stripper column 1 to the reboiler 3, for example, the hydrodynamic cavitation device 9 can be installed on a line directly exiting the stripper column 1. FIG. 3 illustrates this configuration. The hydrodynamic cavitation device 9 is installed downstream of the stripper column 1 and upstream of a reboiler 3 that is used, to maintain the stripped vapours that are directed to the stripper column 1 at an appropriate temperature through the line 29. When the hydrodynamic cavitation device 9 is installed on the reboiler line 7 of the stripper system, it can also be placed within the reboiler 3 itself (not shown). Such configuration may provide for additional hydrodynamic cavitation steps. In another example, the stripper system can have a hydrodynamic cavitation device 9 installed at an outlet of the stripper column 1.

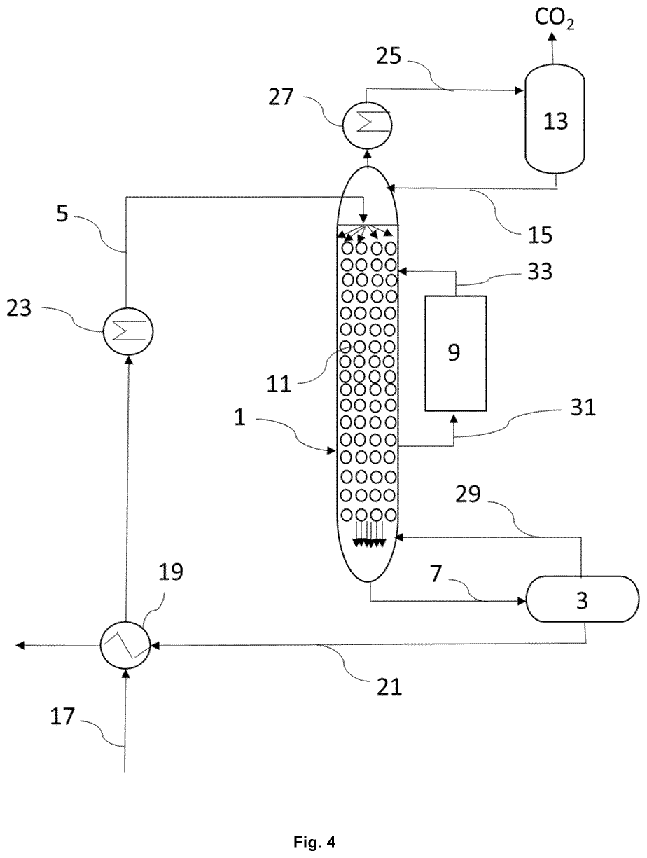

The hydrodynamic cavitation step can finally be of the fourth type, namely a fourth type of hydrodynamic cavitation step performed on at least a part of a liquid portion withdrawn from the stripper column through a withdrawal line 31. The withdrawal line 31 can be placed at any height of the stripper column 1. This involves a stripper system having a hydrodynamic cavitation device 9 installed in parallel to the stripper column 1. Once at least a part of the liquid portion has been treated by this fourth type of hydrodynamic step, the treated part of this liquid portion is then reinjected into the stripper column through a reinjection line 33. Ideally, the reinjection line 31 is presented upstream to the withdrawal line 31 and can also be placed at any height of the stripper column 1. FIG. 4 illustrates this configuration.

The hydrodynamic cavitation device 9 can present a constriction section formed by an orifice plate with one hole. A constriction section can also be formed with an orifice plate comprising multiple holes, for example with two or three holes, a venturi tube, a rotor-stator system, or a liquid whistle. Instead of a constriction section, a vortex diode showing a tangential inlet port and an axial outlet port can also be used to generate the cavitation bubbles.

For example, in the case of an orifice plate with at least one hole, the flow through the main line passes through a constriction where the local velocities suddenly rise due to the reduction in the flow area, resulting in lower pressures that may even decrease to below the vapor pressure of liquid medium. Choosing a correct flow arrangement in the hydrodynamic cavitation device 9 is of paramount importance to maximize the effects of cavitation in desired cost-effectively manner.

The constriction can be a venturi, a single hole or multiple holes in an orifice plate, as described in a study entitled “Beer-brewing powered by controlled hydrodynamic cavitation: Theory and real-scale experiments” by Albanese L. et al. (J. of Cleaner Production, 2017, 142, 1457-1470). The use of multiple-hole orifice plates helps to achieve different intensities of cavitation. Additionally, the number of cavitational events generated in the reactor varies. Thus, the orifice plate set-up offers tremendous flexibility in terms of the operating (control of the inlet pressure, inlet flow rate, temperature) and geometric conditions (different arrangements of holes on the orifice plates, such as circular, triangular pitch, etc., and also the geometry of the hole itself, which alters the resultant fluid shear, leading to different cavitational intensities). The orifice plate set-up offers maximum flexibility and can also be operated at relatively larger scales of operation. It should be also noted that the scale-up of such devices is relatively easier, as the efficiency of the pump increases with an increase in size (flow rate and discharge rate), which will necessarily result in higher energy efficiencies.

For example, hydrodynamic cavitation can also be generated in rotating equipment, such as a rotor-stator system. When the tip speed of the rotating device (impeller) reaches a critical speed, the local pressure near the periphery of the impeller drops and approaches the vapor pressure of the liquid. This results in the generation of vaporous cavities. Subsequently, as the liquid moves away from the impeller to the boundary of the tank, the liquid pressure recovers at the expense of the velocity head. This causes the cavities that have travelled with the liquid bulk to collapse. The energy consumption in these types of reactors is higher, and flexibility over the design parameters is lesser as compared to reactors based on the use of multiple-hole orifice plates. An example of rotating equipment is Rotocav from Cavimax in the UK.

For example, a liquid whistle is a kind of static mixer that passes fluid at high pressure through an orifice and subsequently over a blade. Such a high-pressure homogenizer is a high-pressure positive displacement pump with throttling that operates according to the principle of high-pressure relief. Typically, a high-pressure homogenizer reactor consists of a feed tank and two throttling valves, designated as first stage and second stage, to control the operating pressure in the hydrodynamic cavitation reactor. An example of a technology provider for high-pressure homogenizers used to create hydrodynamic cavitation is Sonic Corporation from the USA. Their Sonolator high-pressure homogenizers use a high-pressure positive displacement pump connected to the Sonolator forces liquid through a specially engineered orifice at pressures to 42 MPa. The fluid changes velocity dramatically over a very short distance and accelerates to over 90 m/sec, creating high shear and turbulence within the process material. Immediately thereafter, the solution impacts a blade set in its path. Extreme hydrodynamic cavitation occurs as the solution flows over the blade where aggressive and turbulent counter currents are formed.

For example, another interesting hydrodynamic cavitational technology is a vortex type Hydrodynamic cavitation generator, “VoDca” from Water Knight in the Netherlands. VoDCa's patented, CFD-optimised design, comprising a tangential inlet and cylindrical axial outlet connected by a disc-shaped chamber, imparts and conserves angular momentum of fluid through the process. It creates a sufficient pressure drop to produce cavities/micro-bubbles which are collapsed in a controlled manner downstream of the system. The equipment achieves a high cavitation yield and the vortex shields the walls from collapsing cavities leading to no erosion. Cavitation Technologies, Inc. (CTi) is another company providing such a solution for hydrodynamic cavitation.

In the anthropogenic carbon dioxide capture process, the solvent which is provided to absorb the carbon dioxide from the flue gas is or comprises an absorbent of carbon dioxide. Such absorbent can for example comprises one or more selected from amines, amino-alcohols, amino acids, ammonia, carbonate salts, bicarbonate salts, hydroxide salts, ionic liquids and any combination thereof, more preferably, the absorbent is or comprises amino-alcohols.

For example, when the absorbent is or comprises amino-alcohols, the amino-alcohols are one or more alkanolamines preferably selected from one or more of monoethanolamine (MEA), diethanolamine (DEA), triethanolamine (TEA), methyldiethanolamine (MDEA), di-isopropanol amine (DIPA), 2-amino-2-methyl-1-propanol (AMP). With preference, when the absorbent comprises amino-alcohols, the absorbent further comprises benzylamine (BZA) and/or piperazine (PZ).

Indeed, alkanolamines are cheap and safe to handle compounds and are commonly classified by the degree of substitution on the central nitrogen; a single substitution denoting a primary amine; a double substitution, a secondary amine; and a triple substitution, a tertiary amine. Alkanolamines have at least one hydroxyl group and one amino group. In general, the hydroxyl group serves to reduce the vapor pressure and increase the solubility in water, while the amine group provides the necessary alkalinity in aqueous solutions to promote the reaction with acid gases. The amines that have proved to be of principal commercial interest for gas purification are monoethanolamine (MEA), diethanolamine (DEA) and methyldiethanolamine (MDEA). Primary alkanolamines such as MEA, provide high chemical reactivity, favored kinetics, medium-to-low absorption capacity and acceptable stability. MEA offers advantages in terms of high chemical reactivity with CO₂ and low cost. These properties can reduce the absorber height and ensure a feasible operation. Although MEA-based scrubbing technology is suitable for acid gas removal and, in particular, anthropogenic capture from fossil-fired plants flue gas, it suffers from several issues during operation, including high energy requirements for stripping: high enthalpy of reaction, low absorption capacity, oxidative and thermal degradation and piping corrosion. Secondary alkanolamines such as DEA and di-isopropanol amine (DIPA), have intermediate properties compared to primary amines and they are considered as an alternative to MEA. DEA is more resistant to degradation and shows lower corrosion strength than MEA, whereas DIPA has a lower energy requirement for solvent regeneration than MEA. Tertiary amines such as triethanolamine (TEA) and MDEA, are characterized by having high equivalent weight, causing low absorption capacity, low reactivity and high stability. Primary and secondary amines offer advantages and limitations compared to tertiary amines for the CO₂ separation process. Primary and secondary amines are very reactive; they form carbamate by direct reaction with CO₂ by zwitterion mechanism. These amines show a limited thermodynamic capacity to absorb CO₂ due to the stable carbamates formation along the absorption process. On the other hand, tertiary amines can only form a bicarbonate ion and protonated amine by the base-catalyzed hydration of CO₂ due to their lack of the necessary N—H bond. Hydration is slower than the direct reaction by carbamate formation and, hence, tertiary amines show low CO₂ absorption kinetics. Sterically hindered amines are considered a type of amines that can improve CO₂ absorption rates in comparison with the common primary and second amines. A sterically hindered amine is formed by a primary or secondary amine in which the amino group is attached to a tertiary carbon atom in the first case or a secondary or tertiary carbon atom. These amines are characterized by forming carbamates of intermediate-to-low stability, introducing a bulky substituent adjacent to the amino group to lower the stability of the carbamate formed by the CO₂-amine reaction. This weaker bond leads to lower energy consumption to release CO₂ is lower than common primary and second amines. An example of sterically hindered amine used in CO₂ capture is 2-amino-2-methyl-1-propanol (AMP). However, these solvents suffer from low CO₂ absorption kinetics. The solvents for CO₂ capturing should have good absorption capacity and kinetics, and low regeneration energy, but there is no single amine solvent that satisfies these requirements. Nowadays, a great amount of interest has been shown in blended amines as a solvent, especially to find the best blending combination for the CO₂ solubility and regeneration performance. The addition of a small amount of tertiary amines (MDEA, TEA) in primary or secondary amines (MEA, DEA) to form a solvent blend, enhances the overall behavior of the solvent in terms of lower energy requirements for solvent regeneration and higher resistance to solvent degradation. For this reason, different researchers are studying novel solvent formulations and blends, involving fast kinetic solvents such as MEA with other slow kinetic solvents like TEA AMP, benzylamine (BZA) and MDEA. Amines such as MEA, DEA and piperazine (PZ) have been used as promoters for MDEA blends. Blends of AMP with PZ have also been used.

Depending on the temperature, the carbon dioxide capture by using ammonia can be classified into two types: (a) a conventional ammonia system, in which the absorption of CO₂ is at ambient temperature (25-40° C.) and does not allow precipitation, and (b) a chilled (precipitating) ammonia system, in which CO₂ absorption occurs at low temperature (about 2-10° C.) and desorption of CO₂-rich stream occurs at a temperature range of 100-150° C. and pressures of 0.20 MPa-14 MPa. This process is called the chilled ammonia process and precipitation of some ammonium carbonate compounds occurs in the absorber. The processes using ammonia are much more complex than amine-based processes and suffer from slow rates of reaction. Issues of unwanted side reactions and problems of high ammonia levels entrained in the treated gas are also encountered.

Concerning the carbonate/bicarbonate system, it can be stated that it has many advantages such as low cost, low toxicity, ease of regeneration, low corrosiveness, low degradation, high stability, and high CO₂ absorption capacity. The carbonate system has been applied in more than 700 plants worldwide for CO₂ and H₂S removal from streams like ammonia synthesis gas, crude hydrogen, natural gas, and town gas. The reaction of CO₂ with potassium carbonate solution is exothermic. The hot potassium carbonate process is useful for gas mixtures containing a high amount of CO₂. The CO₂ absorption by using potassium carbonate solution suffers from slow kinetics. Consequently, promoters (activators) have been used in different studies to improve process efficiency. A precipitating carbonate/bicarbonate system has been proposed by Shell which utilizes K₂CO₃ with a crystallization and concentration step and then a CO₂ absorption step. It was reported that a large reduction in regeneration energy and a lower amount of nitrosamine emitted in comparison to the amine process. Sodium carbonate/bicarbonate solution also can be used as precipitating solvent. These solvents face slow kinetics and mass transfer issues. Precipitation in reboiler and pipeline of the process are other potential issues with the processes involving carbonates/bicarbonates.

Concerning hydroxides salt solutions, different types of hydroxides such as potassium, calcium, and sodium hydroxides can be utilized to remove CO₂ from different gas streams. As NaOH is a strong alkaline, Na⁺ and OH⁻ are almost completely ionized in pure water. Then, the gaseous CO₂ is absorbed physically in the NaOH solution and changes to aqueous CO₂. After that, aqueous CO₂ reacts with OH⁻ to generate HCO₃⁻ and CO₃²⁻. Hydroxides also suffer from precipitation in the reboiler and pipeline of the process.

1-31. (canceled)

32. Method to desorb carbon dioxide from a CO₂-rich solvent in a stripper column (1), the method comprising the steps of
i. providing a first stream comprising a CO₂-rich solvent;
ii. providing a stripper column (1) and a reboiler (3);
iii. passing the first stream through the stripper column (1) under stripping conditions;
iv. recovering a CO₂-rich effluent from the stripper column (1),
v. recovering a reboiler stream from the stripper column (1) and passing the reboiler stream through the reboiler (3), and
vi. recovering a second stream comprising a CO₂-lean solvent from the reboiler (3);
the method is characterized in that it further comprises one or more steps of hydrodynamic cavitation which are performed on the first stream and/or on the reboiler stream, each stream presenting an initial flow velocity and an initial static pressure;
in that the one or more steps of hydrodynamic cavitation are performed by increasing the initial flow velocity of the stream and subsequently decreasing the initial static pressure of the stream;
and in that at least one step of hydrodynamic cavitation is performed within the stripper column (1) and/or at least one step of hydrodynamic cavitation is performed on a stream directly entering or directly exiting the stripper column (1).

33. The method according to claim 32 is characterized in that one or more hydrodynamic cavitation steps are performed in absence of ultrasonic waves.

34. The method according to claim 32 is characterized in that the one or more steps of hydrodynamic cavitation are selected from:
a first type of hydrodynamic cavitation performed on the first stream before step (iii);
a second type of hydrodynamic cavitation performed on the first stream within the stripper column (1);
a third type of hydrodynamic cavitation performed on the reboiler stream;
a fourth type of hydrodynamic cavitation performed on at least one part of a liquid portion withdrew from the stripper column (1) followed by reinjecting said part of the liquid portion that has been subjected to hydrodynamic cavitation into the stripper column (1); and
any combination thereof.

35. The method according to claim 32 is characterized in that the initial static pressure of the first stream is ranging between 0.10 MPa and 0.30 MPa.

36. The method according to claim 32 is characterized in that the first stream provided at step (i) shows a temperature ranging from 50° C. to less than 130° C. and at least a part of the heat required for heating the first stream to the said temperature is provided by heat transfer from the second stream.

37. The method according to claim 32 is characterized in that at least one step of hydrodynamic cavitation is carried out on the reboiler stream, the step of hydrodynamic cavitation being carried out before and/or during a step of heating the reboiler stream.

38. The method according to claim 32 is characterized in that at least one step of hydrodynamic cavitation is performed on a stream directly exiting the stripper column (1) wherein the stream is the reboiler stream and wherein no other step is performed between exiting of reboiler stream from the stripper column (1) and the step of hydrodynamic cavitation.

39. The method according to claim 32 is characterized in that at least one step of hydrodynamic cavitation is performed within the stripper column (1) by means of one or more hydrodynamic cavitation devices being arranged within the stripper column (1).

40. The method according to claim 32 is characterized in that at least one step of hydrodynamic cavitation is performed on a stream directly exiting the stripper column (1) wherein the stream is a liquid portion withdrew from the stripper column (1) and reinjected into the stripper column (1) and wherein no other step than step of hydrodynamic cavitation is performed between the withdrawal of the liquid portion and its reinjection into the stripper column (1).

41. The method according to claim 32 is characterized in that one or more steps of hydrodynamic cavitation are performed on the first stream and at least one additional hydrodynamic cavitation step is performed on the reboiler stream.

42. The method according to claim 32 is characterized in that one or more steps of hydrodynamic cavitation are performed on the first stream and at least one additional hydrodynamic cavitation step is performed within the reboiler (3).

43. Anthropogenic carbon dioxide capture process, the process comprising the following steps:
a) providing a stream of CO₂-containing gas;
b) providing a solvent being or comprising an absorbent of carbon dioxide;
c) contacting the stream of CO₂-containing gas with the solvent being or comprising an absorbent, so as to recover a CO₂-rich solvent;
d) directing the CO₂-rich solvent in a stripper column (1);
e) desorbing the carbon dioxide from the CO₂-rich solvent;
the process is characterized in that step (e) is performed according to the method to desorb carbon dioxide from a CO₂-rich solvent in a stripper column (1) as defined in claim 32.

44. The process according to claim 43 is characterized in that the absorbent comprises one or more selected from amines, amino-alcohols, amino acids, ammonia, carbonate salts, bicarbonate salts, hydroxide salts, ionic liquids and any combination thereof.

45. Stripper system for capturing carbon dioxide in a CO₂-rich solvent as defined in the method according to claim 32, the stripper system comprising
i. a stripper column (1), the stripper column (1) having a top zone and a bottom zone,
ii. a reboiler (3), wherein the reboiler (3) is arranged downstream of the stripper column (1) and the bottom zone of the stripper column (1) is in fluidic connection with the reboiler (3), an input line (5) in fluidic connection with the top zone of the stripper column (1), and
iii. a reboiler line (7) between the bottom zone of the stripper column (1) and the reboiler (3),
the stripper system is characterized in that it comprises at least one hydrodynamic cavitation device (9), the one or more hydrodynamic cavitation devices (9) presenting a constriction section and/or a vortex diode showing a tangential inlet port and an axial outlet port;
and wherein at least one hydrodynamic cavitation device (9) is placed
within the stripper column (1); and/or
on a line directly entering or directly exiting the stripper column (1); and/or
at an inlet or at an outlet of the stripper column (1).

46. The stripper system according to claim 45 is characterized in that the line directly entering the stripper column (1) is selected from the input line (5) and a line in parallel of the stripper column (1).

47. The stripper system according to claim 45 is characterized in that the line directly exiting the stripper column (1) is selected from the reboiler line (7) and a line in parallel of the stripper column (1).

48. The stripper system according to claim 45 is characterized in that the constriction section is formed by one or more selected from an orifice plate with at least one hole, a venturi tube, a rotor-stator system and a liquid whistle.

49. The stripper system according to claim 45 is characterized in that the stripper column (1) comprises a packed bed (11).

50. The stripper system according to claim 45 is characterized in that the stripper system further comprises a gas/liquid separator (13), the gas/liquid separator (13) being downstream and fluidly connected to the top zone of the stripper column (1).

51. The stripper system according to claim 50 is characterized in that it further comprises a gas compressor downstream of the gas/liquid separator (13) and/or a recycling line (15) to recycle liquid into the top zone of the stripper column (1).

52. Installation to perform an anthropogenic carbon dioxide capture process according to any claim 43, the installation comprising
i. an absorber column, the absorber column showing a top zone and a bottom zone, the top zone of the absorber column presenting an output exhaust;
ii. a feed line being a first line in fluidic connection with the bottom zone of the absorber column;
iii. a stripper system
iv. a second line (17) fluidly connecting the bottom zone of the absorber column with an input line (5) of said stripper system
the installation is characterized in that the stripper system is the stripper system for desorbing carbon dioxide from a CO₂-rich solvent.
